(19) United States
(12) Patent Application Publication
(10) Pub. No.: US 2004/0251141 A1
(43) Pub. Date: Dec. 16, 2004

(54) Electroless plating apparatus and electroless plating method

(75) Inventors: Gishi Chung, Nirasaki-shi (JP); Yoshinori Marumo, Chino-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 10/861,447

(22) Filed: Jun. 7, 2004

(30) Foreign Application Priority Data
Jun. 13, 2003 (JP) 2003-169295

(51) Int. Cl. B05C 3/02; C25D 5/08

(52) U.S. Cl. 205/133; 205/123; 205/135

(57) ABSTRACT

A plate and a substrate are placed to face each other and a treatment liquid is jetted from a treatment liquid jetting portion of the plate, thereby treating the substrate. At this time, bubbles in the treatment liquid are discharged from an opening formed in the plate, thereby enabling reduction in treatment nonuniformity caused by the bubbles. The formation of a slope toward the opening on the plate makes it possible to further promote the removal of the bubbles from the treatment liquid.

### CROSS-REFERENCE TO THE INVENTION

This application is based upon and claims the benefit of priority from the prior Japanese Patent Application No. 2003-169295, filed on Jun. 13, 2003; the entire contents of which are incorporated herein by reference.

### BACKGROUND OF THE INVENTION

1. Field of the Invention

The present invention relates to an electroless plating apparatus that performs electroless plating and a method of the electroless plating.

2. Description of the Related Art

Wiring is formed on a semiconductor substrate in fabricating a semiconductor device. A material used for the wiring is, for example, copper, and after a copper seed layer is formed by physical vapor deposition (PVD), for example, a sputtering method, copper electrolytic plating is performed so that a copper wiring layer is formed. In this method, it is difficult to form electroplating on a surface to be plated on which no seed layer is formed.

As a plating method not requiring a seed layer, an electroless plating method is available. In the electroless plating, which is a method of forming a plating film by chemical reduction, the formed plating film acts as an autocatalyst, thereby enabling continuous formation of the plating film. The electroless plating is advantageous in that no consideration to nonuniformity of the film thickness (particularly, step coverage in recessed portions and protruding portions) is necessary in forming the seed layer since it does not require advance formation of a seed layer (or, does not require the formation of the seed layer on the entire surface to be plated). The use of the electroless plating also allows the selective formation of a metal material such as CoWP on a copper wiring layer pattern (see U.S. Pat. No. 6,342,733).

In the electroless plating, bubbles may possibly be generated in a plating solution due to the generation of gas and to other causes during plating reaction to adhere to a substrate to be treated, thereby causing pin holes in a plating film or nonuniformity of the plating film. In order to solve this problem, such a method is sometimes adopted that a surface to be plated of a substrate is placed to face upward so that bubbles are moved by buoyancy (see paragraph No. 0011 of Japanese Patent Application Laid-open No. 2000-226671).

### SUMMARY OF THE INVENTION

Only placing the surface to be plated of the substrate to face upward is not necessarily sufficient for removing the bubbles. The bubbles diffuse into the atmosphere when the level of the plating solution is exposed to the atmosphere, but when the plating solution is confined in a hermetic space, the bubbles are stagnant in the plating solution, which may possibly result in their re-adhesion or the like to the substrate.

In view of the above, it is an object of the present invention to provide an electroless plating apparatus and an electroless plating method capable of achieving higher reliable removal of bubbles from a treatment liquid.

A. In order to attain the object stated above, an electroless plating apparatus according to one of the aspects of the present invention includes: a substrate holding unit configured to hold a substrate; a plate disposed to face the substrate held by the substrate holding unit; a treatment liquid jetting portion formed in the plate and configured to jet a treatment liquid; a bubble discharge portion formed in the plate and configured to discharge a bubble in the treatment liquid held between the plate and the substrate; and an interval adjusting unit configured to vary an interval between the plate and the substrate.

The substrate is placed to face the plate and the treatment liquid is jetted from the treatment liquid jetting portion of the plate, so that the substrate is treated. At this time, the bubble discharge portion formed in the plate discharges bubbles in the treatment liquid, thereby reducing nonuniform treatment caused by the bubbles.

The “treatment liquid” mentioned here at least includes a chemical for electroless plating, and in some cases, may include a cleaning liquid used for cleaning of electroless plating, and other liquid. In other words, the “electroless plating apparatus” includes both an apparatus that performs only electroless plating using a chemical for electroless plating as the “treatment liquid” and an apparatus that not only performs such electroless plating but also performs cleaning of the electroless plating.

Here, the bubble discharge portion may have an opening formed on the plate and a pipe connected to the opening.

Bubbles in the treatment liquid can be discharged from the opening through the pipe.

(1) The plate may have a slope formed thereon in a direction toward the opening.

The bubbles are guided by the slope to move toward the opening, which enables the quick discharge of the bubbles in the treatment liquid. The slope preferably has an angle of 2° or more relative to a surface of the plate. The discharge of the bubbles can be promoted.

(2) The plate may have a groove formed thereon and the opening may be disposed in the groove.

The bubbles are guided by the groove to move toward the opening, which promotes the discharge of the bubbles out of the treatment liquid. Further, if the groove has a slope on a side face thereof in a direction toward the opening (for example, the slope has an angle of 2° or more relative to a surface of the plate), the discharge of the bubbles is further promoted..

(3) The electroless plating apparatus may further include a gas/liquid separator connected to the pipe.

The discharged bubbles are in a state of containing not only a gas component but also a liquid component (mist or the like of the treatment liquid). The gas/liquid separator can separate the gas component and the liquid component from each other.

(4) The electroless plating apparatus may further include a pressure reducing unit configured to reduce a pressure in the pipe.

The pressure inside the pipe is reduced, so that the discharge of the bubbles can be promoted.

(5) The electroless plating apparatus may further include a rinsing liquid injecting unit configured to inject a rinsing liquid into the pipe.

The rinsing liquid can clean the inside of the pipe and the opening. Note that pure water, for example, is usable as the rinsing liquid.

B. An electroless plating method according to another aspect of the present invention includes: placing a plate and a substrate to be adjacent to and face each other, the plate including a treatment liquid jetting portion configured to jet a treatment liquid and a bubble discharge portion configured to discharge a bubble in the treatment liquid; jetting the treatment liquid from the treatment liquid jetting portion to form a layer of the treatment liquid between the plate and the substrate; and discharging the bubble in the layer of the treatment liquid from the bubble discharge portion during the supply of the treatment liquid.

The plate and the substrate are placed to face each other and the treatment liquid is jetted from the treatment liquid jetting portion of the plate, so that the substrate is treated. At this time, the bubbles in the treatment liquid are discharged by the bubble discharge portion of the plate, thereby reducing nonuniform treatment caused by the bubbles.

### BRIEF DESCRIPTION OF THE DRAWINGS

FIG. 1 is a partial cross sectional view showing an electroless plating apparatus according to one embodiment of the present invention.

FIG. 2A is a plane view showing an example of a bottom face of an upper plate of the electroless plating apparatus shown in FIG. 1.

FIG. 2B is a cross sectional view showing an example of a cross section of the upper plate of the electroless plating apparatus shown in FIG. 1.

FIG. 3 is a reference cross sectional view showing a cross section of an upper plate having no bubble removal port.

FIG. 4A is a top view showing an upper plate having bubble removing grooves.

FIG. 4B is a cross sectional view showing the upper plate having the bubble removing grooves.

FIG. 4C is an enlarged cross sectional view showing the upper plate having the bubble removing grooves.

FIG. 5 is a flowchart showing an example of the procedure for performing electroless plating through the use of the electroless plating apparatus according to the embodiment of the present invention.

FIG.6 is a partial cross sectional view showing the state of the electroless plating apparatus when the electroless plating is performed according to the procedure shown in FIG. 5.

FIG. 7 is a partial cross sectional view showing the state of the electroless plating apparatus when the electroless plating is performed according to the procedure shown in FIG. 5.

FIG. 8 is a partial cross sectional view showing the state of the electroless plating apparatus when the electroless plating is performed according to the procedure shown in FIG. 5.

FIG. 9 is a partial cross sectional view showing the state of the electroless plating apparatus when the electroless plating is performed according to the procedure shown in FIG. 5.

FIG. 10 is a partial cross sectional view showing the state of the electroless plating apparatus when the electroless plating is performed according to the procedure shown in FIG. 5.

FIG. 11 is a partial cross sectional view showing the state of the electroless plating apparatus when the electroless plating is performed according to the procedure shown in FIG. 5.

FIG. 12 is a partial cross sectional view showing the state of the electroless plating apparatus when the electroless plating is performed according to the procedure shown in FIG. 5.

### DESCRIPTION OF THE EMBODIMENTS

Hereinafter, an electroless plating apparatus according to one embodiment of the present invention will be described in detail with reference to the drawings.

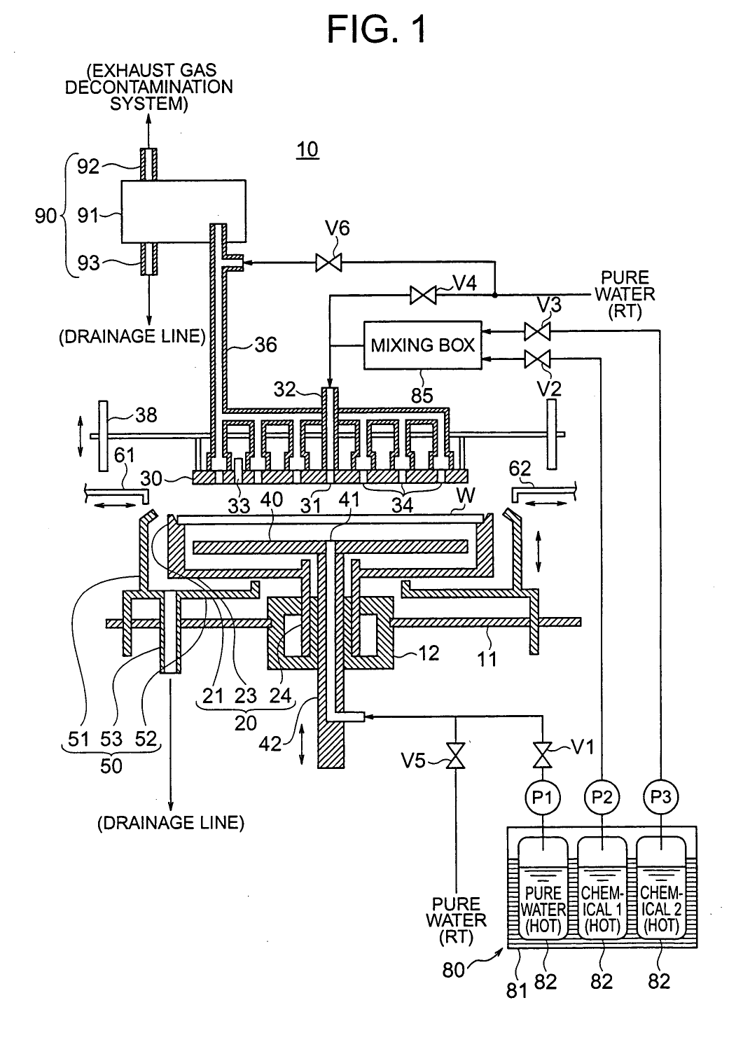

FIG. 1 is a partial cross sectional view showing the configuration of an electroless plating apparatus 10 according to one embodiment of the present invention.

The electroless plating apparatus 10 uses treatment liquids, and with the treatment liquids, it is capable of subjecting a wafer W being a substrate to: electroless plating; pre-treatment, activation, and post-treatment of the electroless plating; and cleaning after the plating.

Therefore, the treatment liquids can include, besides a chemical for electroless plating, various kinds of liquids such as chemicals for the pre-treatment and post-treatment of the plating, an activating liquid, and a cleaning liquid (for example, pure water).

As the chemical used for the electroless plating, a solution in which the mixture of the following materials are dissolved in pure water is usable.

1) metallic salt: This is a material to supply metal ions constituting a plating film, and is, for example, copper sulfate, copper nitrate, or copper chloride when the plating film is copper.

2) complexing agent: This is a material to complex metal so as to prevent the precipitation of the metallic ions as a hydroxide under strong alkalinity, thereby improving stability in a liquid. Examples usable as an amine-based material are HEDTA, EDTA, and ED, and examples usable as an organic material are citric acid, tartaric acid, and gluconic acid.

3) reducing agent: This is a material to cause catalytic reduction/precipitation of the metal ions. Examples of usable materials are hypochlorous acid, glyoxylic acid, stannic chloride, a potassium borohydride compound, and cobalt (II) nitrate.

4) stabilizer: This is a material to prevent spontaneous decomposition of a plating solution caused by nonuniformity of an oxide (copper (II) oxide when a plating film is copper). Examples usable as a nitrogen-based material are bipyridyl, cyanide, thiourea, 0-phenanthoroline, and neocuproine, each forming a complex preferentially with monovalent copper.

5) pH buffer: This is a material to suppress the change in pH when the reaction of a plating solution has progressed, and usable examples are boric acid, carbonic acid, and oxycarbonic acid.

6) additive: The additive includes a material to promote and suppress the deposition of a plating film and a material to reform the surface or a plating film.

Examples usable as a sulfuric material to suppress the deposition speed of a plating film to stabilize a plating solution and improve the properties of the plating film are thiosulfuric acid and 2-MBT.

As a nonionic material of a surfactant to lower surface tension of a plating solution to realize uniform application of the plating solution on the surface of the wafer W, polyalkylene glycol and polyethylene glycol, for example, are usable.

As shown in FIG. 1, the electroless plating apparatus 10 has a base 11, a motor 12, a wafer chuck 20 being a substrate holding unit, an upper plate 30, a lower plate 40, a cup 50, nozzle arms 61, 62, a liquid supply mechanism 80, and a gas/liquid separating and collecting unit 90. Here, the motor 12, the wafer chuck 20, the upper plate 30, the lower plate 40, the cup 50, and the nozzle arms 61, 62 are directly or indirectly connected to the base 11 so that the movement and so on of these elements and the base 11 are performed as a unit.

The wafer chuck 20 holds and fixes the wafer W and is composed of wafer holding claws 21, a wafer chuck bottom plate 23, and a wafer chuck support portion 24.

The plural wafer holding claws 21 are arranged on an outer periphery of the wafer chuck bottom plate 23 to hold and fix the wafer W. At this time, the wafer W is held with a surface to be treated thereof facing upward, so that bubbles adhering to the wafer W are moved upward by buoyancy to be easily removed from the surface of the wafer W.

The wafer chuck bottom plate 23 is a flat plate in a substantially circular shape connected to a top face of the wafer chuck support portion 24 and is disposed on a bottom face of the cup 50.

The wafer chuck support portion 24, which is in a substantially cylindrical shape, is connected to a circular opening formed in the wafer chuck bottom plate 23 and constitutes a rotating shaft of the motor 12. As a result, when the motor 12 is driven, the wafer chuck 20 can be rotated while it keeps holding the wafer W.

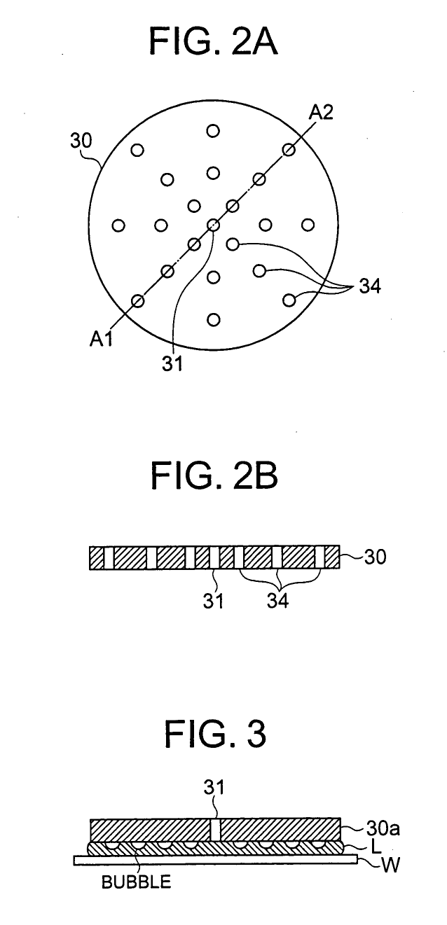

FIG. 2A and FIG. 2B are a plane view showing an example of a bottom face of the upper plate 30 and a cross sectional view showing an example of a cross section thereof. FIG. 2B shows the upper plate 30 taken along the A1-A2 line in FIG. 2A.

As shown in FIG. 1, FIG. 2A, and FIG. 2B, the upper plate 30 is a substantially circular flat plate disposed to face the top face of the wafer W, and it supplies a treatment liquid such as a chemical and pure water to the top face of the wafer W, heats the treatment liquid, and removes bubbles from the treatment liquid.

The upper plate 30 has a heater H (not shown), a treatment liquid jetting port 31, a treatment liquid inflow portion 32, a temperature measuring mechanism 33, bubble removal ports 34, and a bubble outflow portion 36, and is connected to a hoisting/lowering mechanism 38.

The heater H is a heating element such as a heating wire for heating the upper plate 30. An amount of heat generated by the heater H is controlled by a not-shown control unit so that the upper plate 30 and accordingly the wafer W are kept at a desired temperature (for example, within a range from room temperature to about 90° C.) according to the result of the temperature measurement by the temperature measuring mechanism 33.

The treatment liquid jetting port 31 is formed in the bottom face of the upper plate 30 and jets the treatment liquid that flows therein from the treatment liquid inflow portion 32.

As shown in FIG. 2A and FIG. 2B, the treatment liquid jetting port 31 is disposed at the center of the bottom face of the upper plate 30. When the treatment liquid jetting port 31 jets the treatment liquid while the bottom face of the upper plate 30 is kept adjacent to and aligned with the top face of the wafer W, a layer of the treatment liquid is formed between the upper-plate 30 and the wafer W. When the treatment liquid is kept jetted, the treatment liquid flows out from the periphery of the upper plate 30.

In FIG. 2A and FIG. 2B, only the single treatment liquid jetting port 31 is provided, but by providing a plurality of the treatment liquid jetting ports 31, uniform supply of the treatment liquid and uniform temperature of the substrate are realized. For example, they may be arranged from the center of the bottom face of the upper plate 30 radially in, for example, four directions or three directions or arranged on a grid. In other words, the number, shape, and arrangement of the heater H and the treatment liquid jetting ports 31 may be appropriately selected as long as the temperature and the distribution of the treatment liquid supply amount are resultantly made uniform on the upper plate 30.

The treatment liquid inflow portion 32, which is disposed on the top face side of the upper plate 30 and into which the treatment liquid flows, distributes the treatment liquid flowing thereto to the treatment liquid jetting port 31. Pure water (RT: room temperature) or heated chemicals 1, 2 (for example, within a range from room temperature to 90° C.) can be switchingly used as the treatment liquid flowing into the treatment liquid inflow portion 32. Further, the chemicals 1, 2 (in some cases, a plurality of chemicals containing other chemicals are mixed therein) mixed in a later-described mixing box 85 can also flow into the treatment liquid inflow portion 32.

The temperature measuring mechanism 33 is a temperature measuring element such as a thermocouple buried in the upper plate 30 and measures the temperature of the upper plate 30.

The bubble removal ports 34 are holes, namely, openings formed in the bottom face of the upper plate 30, and remove bubbles from the treatment liquid held between the wafer W and the upper plate 30 to send the bubbles to the bubble outflow portion 36. Here, the shape of the bubble removal ports 34 is substantially circular, but is not limited to this shape. Various shapes such as an elliptic shape and a rectangular shape are adoptable. Further, the bubble removal ports 34 and the treatment liquid jetting port 31 may be different in size. For example, the diameters of the bubble removal ports 34 and the treatment liquid jetting port 31 may be set to 2 mm to 3 mm and 1 mm respectively.

There is a possibility that bubbles may be generated in the treatment liquid (for example, an electroless plating solution or a cleaning liquid) to impair uniformity of plating or cleaning. The generation of the bubbles is caused by, for example, the residue of the atmospheric air between the wafer W and the upper plate 30 or by the generation of gas (for example, hydrogen gas) from the electroless plating solution.

FIG. 3 is a reference cross sectional view showing a cross section of an upper plate 30a having no bubble removal port 34. In this drawing, bubbles in a treatment liquid L stay on a bottom face of the upper plate 30a, so that they may possibly cause nonuniform plating or cleaning of the wafer W. On the contrary, in this embodiment, the bubble removal ports 34 remove the bubbles in the electroless plating solution, thereby preventing the occurrence of nonuniform treatment caused by the bubbles.

In FIG. 2A and FIG. 2B, the bubble removal ports 34 are radially arranged in 8 directions as an example to realize higher efficiency of the bubble removal. Other arrangement of the bubble removal ports may be adopted such as appropriately dispersed arrangement on the upper plate 30. Further, when a plurality of the treatment liquid jetting ports 31 are provided the dispersed arrangement of both the treatment liquid jetting ports 31 and the bubble removal ports 34 will realize high efficiency both in the supply of the treatment liquid and the removal of the bubbles, which makes it possible to improve treatment uniformity.

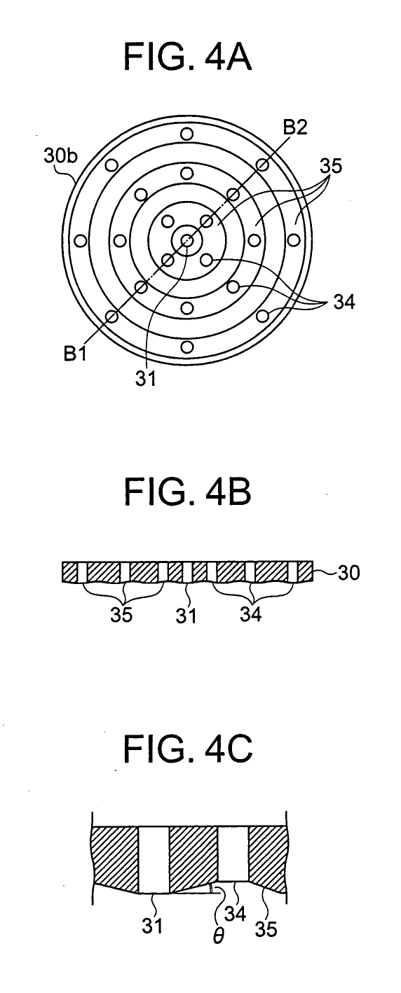

FIG. 4A, FIG. 4B, and FIG. 4C are a top view, a cross sectional view, and an enlarged cross sectional view respectively, showing an upper plate 30b having bubble removing grooves 35. FIG. 4B and FIG. 4C are cross sectional views showing the upper plate 30b taken along the B1-B2 line in FIG. 4A.

Here, the plural ring-shaped bubble removing grooves 35 are coaxially arranged in the upper plate 30b, and bubble removal ports 34 are formed in the bubble removing grooves 35. Bubbles drop into the bubble removing grooves 35 to be further discharged from the bubble removal ports 34, so that efficient removal of the bubbles is enabled.

The plural bubble removing grooves 35 are coaxially arranged with respect to the center of the upper plate 30. This is because bubbles tend to move from the center of the upper plate 30 toward the periphery thereof. Since the treatment liquid moves from the center of the upper plate 30 toward the periphery thereof, the bubbles also move along the flow of the treatment liquid. The bubbles moving toward the periphery of the upper plate 30 are caught in the bubble removing grooves 35 in the course of the movement to be quickly removed.

Side faces of the bubble removing grooves 35 are slanted toward the bubble removal ports 34 by an angle θ. This slope is intended for guiding the bubbles on the upper plate 30 to the bubble removal ports 34. If the angle θ of this slope is 2° or more, the bubbles can be efficiently guided to the bubble removal ports 34 owing to buoyancy.

The bubble outflow portion 36 is a path for guiding the bubbles discharged from the bubble removal ports 34 to the gas/liquid separating and collecting unit 90. Paths from the plural bubble removal ports 34 merge together here to be connected to the gas/liquid separating and collecting unit 90. Further, a rinsing liquid such as pure water is injectable to the bubble outflow portion 36 via a valve V6, so that the bubble outflow portion 36 and the bubble removal ports 34 can be cleaned with the rinsing liquid.

The hoisting/lowering mechanism 38 is connected to the upper plate 30 and moves up and down with the upper plate 30 facing the wafer W, so that it can control the interval between the upper plate 30 and the wafer W within a range, for example, from 0.1 mm to 500 mm. The upper plate 30 is brought closer to the wafer W (for example, the interval between the wafer W and the upper plate 30 is 2 mm or less) during the electroless plating, thereby limiting the size of a space therebetween. This can realize the uniform supply of the treatment liquid onto the surface of the wafer W and the reduction in an amount of the treatment liquid used.

As shown in FIG. 1, the lower plate 40 is a substantially circular flat plate disposed to face the bottom face of the wafer W, and heated pure water is supplied to a bottom face of the lower plate 40 while it is positioned close to the wafer W, so that the wafer W can be appropriately heated.

The lower plate 40 has a treatment liquid jetting port 41 formed at the center of a top face thereof and is supported by a support portion 42.

A treatment liquid that has passed through the inside of the support portion 42 is jetted from the treatment liquid jetting port 41. Pure water. (RT: room temperature) or the heated pure water (for example, within a temperature range from room temperature to about 60° C.) can be switchingly used as the treatment liquid.

The support portion 42 passes through the motor 12 to be connected to a hoisting/lowering mechanism (not shown) being an interval adjusting unit. When the hoisting/lowering mechanism is operated, the support portion 42 and accordingly the lower plate 40 can be moved up and down.

The cup 50, which holds the wafer chuck 20 therein, is intended for receiving and discharging the treatment liquid that has been used for treating the wafer W, and has a cup side portion 51, a cup bottom plate 52, and a drain pipe 53.

The cup side portion 51 is in a substantially cylindrical shape whose inner periphery extends along an outer periphery of the wafer chuck 20, and an upper end thereof is positioned near a position above a holding surface of the wafer chuck 20.

The cup bottom plate 52 is connected to a lower end of the cup side portion 51 and has an opening at a position corresponding to the motor 12, and at a position corresponding to the opening, the wafer chuck 20 is disposed.

The drain pipe 53, which is connected to the cup bottom plate 52, is a pipe for discharging a waste liquid (the treatment liquid that has treated the wafer W) from the cup 50 to a drainage line or the like of a factory where the electroless plating apparatus 10 is installed.

The cup 50 is connected to a not-shown hoisting/lowering mechanism so that it is capable of moving up and down relative to the base 11 and the wafer W.

The nozzle arms 61, 62 are disposed near the top face of the wafer W and jet a fluid such as the treatment liquid and air from openings formed at tips thereof. Pure water, a chemical, or nitrogen gas is appropriately selected as the fluid to be jetted. Moving mechanisms (not shown) to move the nozzle arms 61, 62 in a direction toward the center of the wafer W are connected to the nozzle arms 61, 62 respectively. The nozzle arms 61, 62 are moved to a position above the wafer W when the fluid is to be jetted to the wafer W, and are moved to the outside of the outer periphery of the wafer W when the jetting is finished. Note that the number of the nozzle arms may be one, or three or more depending on the amount and kind of the jetted chemicals.

The liquid supply mechanism 80 supplies the treatment liquid and so on to the upper plate 30 and the lower plate 40, and is constituted of a temperature adjusting mechanism 81, treatment liquid tanks 82, 83, 84, pumps P1 to P3, valves V1 to V6, and the mixing box 85. Incidentally, FIG. 1 shows a case where two kinds of chemicals, namely, the chemicals 1, 2 are used, but the number of the treatment tanks, pumps, valves may be appropriately set according to the number of chemicals that are mixed in the mixing box 85.

The temperature adjusting mechanism 81, which contains warm water and has therein the treatment liquid tanks 82 to 84, is an apparatus to heat the treatment liquids (the pure water, the chemicals 1, 2) in the treatment liquid tanks 82 to 84 with the warm water, and it heats the treatment liquids appropriately, for example, within a range from room temperature to about 90° C. For this temperature adjustment, for example, a water bath, an immersion heater, or an external heater can be appropriately used.

Note that the temperature adjusting mechanism can be separately provided in a chemical supply line. For the temperature adjustment in this case, lamp heating, resistance heating, or the like can be appropriately used.

The treatment liquid tanks 82, 83, 84 are tanks to contain the pure water, the chemicals 1, 2 respectively.

The pumps P1 to P3 suck the treatment liquids out of the treatment liquid tanks 82 to 84. Note that the sending of the treatment liquids out of the treatment liquid tanks 82 to 84 respectively may be done by pressure increase of the treatment liquid tanks 82 to 84.

The valves V1 to V3 open/close the pipes to allow the supply of the treatment liquid and to stop the supply of the treatment liquid. Further, the valves V4 to V6 are intended for allowing the supply of the pure water at room temperature (not heated) to the upper plate 30, the lower plate 40, and the bubble outflow portion 36 respectively.

The mixing box 85 is a vessel in which the chemicals 1, 2 supplied from the treatment liquid tanks 83, 84 are mixed.

The chemicals 1, 2 that are appropriately mixed in the mixing box 85 and temperature-adjusted can be sent to the upper plate 30. Further, the temperature-adjusted pure water can be sent to the lower plate 40 when necessary.

The gas/liquid separating and collecting unit 90 separates gas and liquid from each other to prevent mist of the treatment liquid from being mixed into gas. The gas/liquid separating and collecting unit 90 is composed of a gas/liquid separating and collecting unit body 91, a gas discharge portion 92, and a liquid discharge portion 93, and connected to the bubble outflow portion 36.

Since the bubbles flow into the gas/liquid separating and collecting unit body 91 from the bubble outflow portion 36, the bubbles and the treatment liquid flow in a mixed manner into the gas/liquid separating and collecting unit body 91. This inflow is separated to a gas component and a liquid component in the gas/liquid separating and collecting unit body 91. The gas component is sent through the gas discharge portion 92 to an exhaust gas decontamination system to undergo decontamination treatment (removal of noxious substance and so on mixed in the gas component). The liquid component is sent from the liquid discharge portion 93 to the drainage line.

Note that the reduction of the pressure in the gas/liquid separating and collecting unit body 91 will accelerate the passage of the bubbles through the bubble inflow portion 36, thereby promoting the removal of the bubbles from the treatment liquid.

(Electroless Plating Process in Detail)

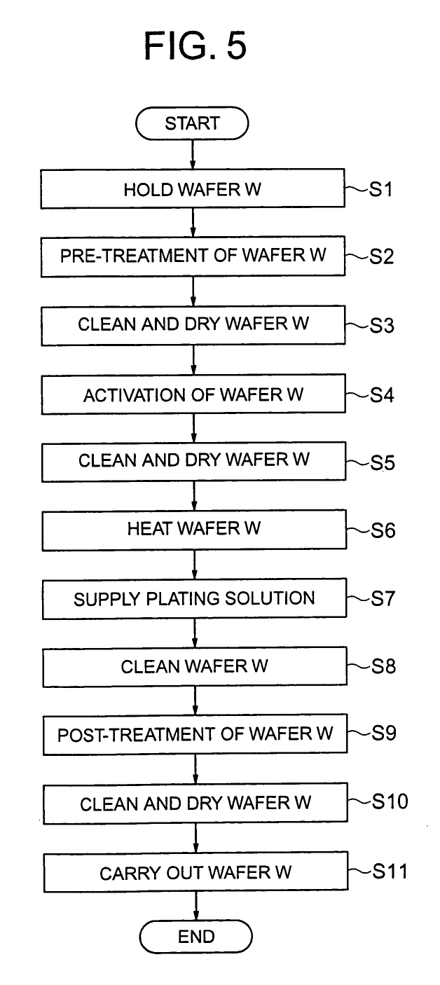

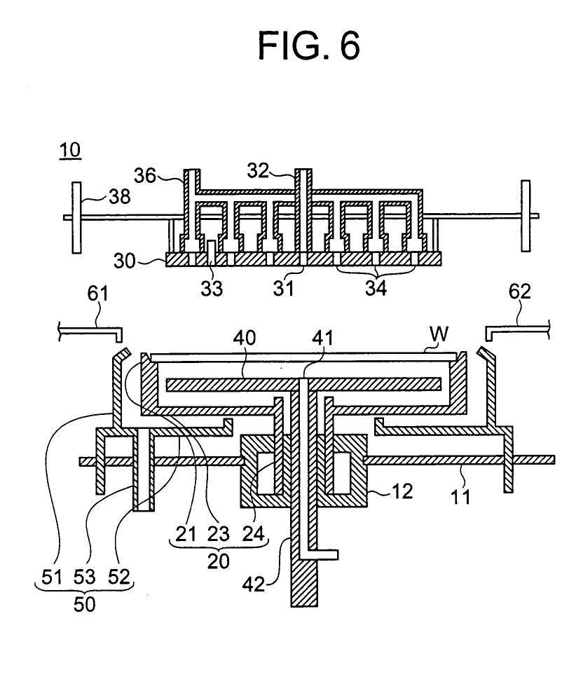

FIG. 5 is a flowchart showing an example of the procedure for performing the electroless plating of the wafer W through the use of the electroless plating apparatus 10. FIG. 6 to FIG. 12 are partial cross sectional views showing the states of the electroless plating apparatus 10 in respective processes when the electroless plating is performed according to the procedure shown in FIG. 5. Hereinafter, the procedure will be described in detail using FIG. 5 to FIG. 12.

(1) Hold Wafer W (Step S1 and FIG. 6)

The wafer W is held on the wafer chuck 20. For example, a not-shown suction arm (substrate transfer mechanism) sucking the wafer W by the top face thereof places the wafer W on the wafer chuck 20. Then, the wafer W is held and fixed by the wafer holding claws 21 of the wafer chuck 20. Note that the suction arm can be moved in a horizontal direction below the top face of the wafer W when the cup 50 is lowered.

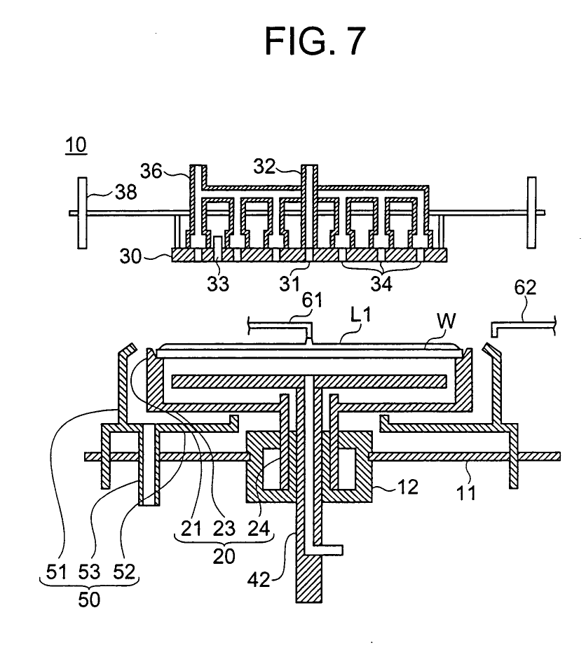

(2) Pre-Treatment of Wafer W (Step S2 and FIG. 7)

The wafer W is pre-treated in such a manner that the wafer W is rotated and the pre-treatment liquid (for example, sulfuric acid) is supplied to the top face of the wafer W from the nozzle arm 61 or the nozzle arm 62.

The rotation of the wafer W is caused by rotating the wafer chuck 20 by the motor 12, and the rotation speed at this time can be set to, for example, 100 rpm to 200 rpm.

One or both of the nozzle arms 61, 62 move(s) to the position above the wafer W to jet the pre-treatment liquid. As an amount to be jetted at this time, for example, about 100 mL will suffice for forming a puddle (layer) of the pre-treatment liquid on the wafer W. However, the amount to be jetted may be increased when necessary.

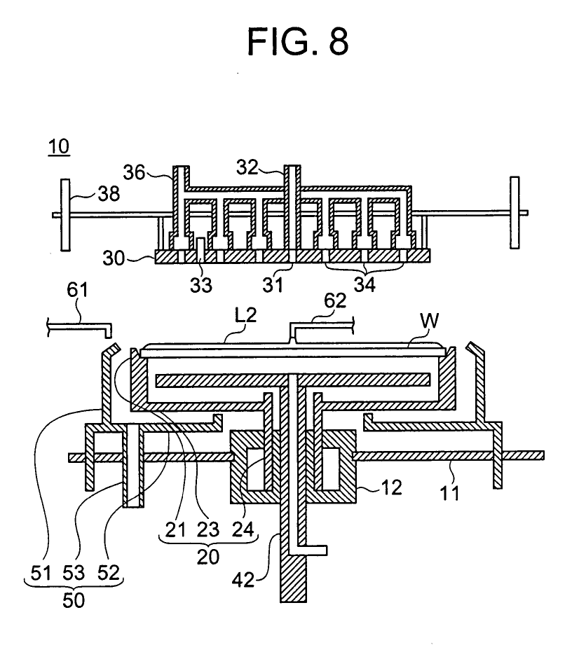

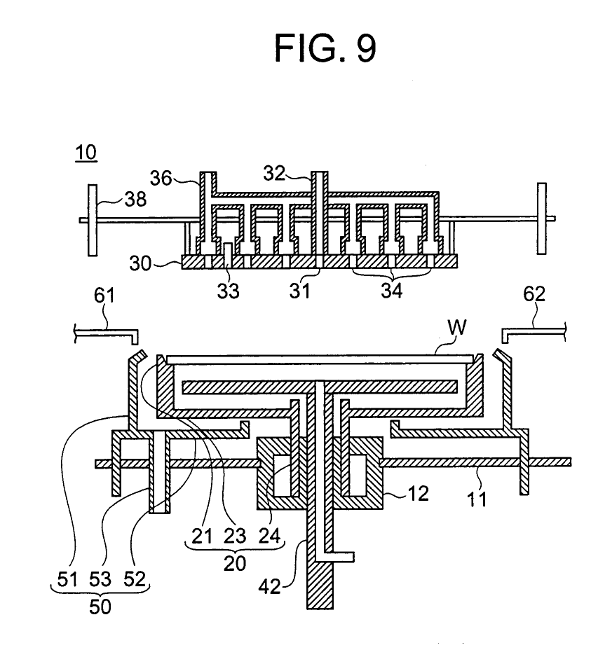

(3) Clean and Dry Wafer W (Step S3, and FIG. 8 and FIG. 9)

1) The wafer W is cleaned with pure water (FIG. 8). For this cleaning, the nozzle arm 61 or the nozzle arm 62 is moved to the position above the wafer W to supply the pure water to the wafer W. At this time, it is preferable to supply pure water from the treatment liquid jetting port 41 of the lower plate 40.

Rotating the wafer W during the cleaning of the wafer W can realize higher uniformity of the cleaning of the wafer W.

2) The wafer W is dried (FIG. 9). Specifically, the supply of the pure water to the wafer W is stopped and the wafer W is rotated at high speed, so that the pure water on the wafer W is removed. Depending on cases, nitrogen gas may be jetted from the nozzle arm 61 or the nozzle arm 62 to promote the drying of the wafer W.

(4) Activation of Wafer W (Step S4)

For the activation of the wafer W, the wafer W is rotated and the activating liquid is supplied to the top face of the wafer W from the nozzle arm 61 or the nozzle arm 62.

The rotation of the wafer W is caused by rotating the wafer chuck 20 by the motor 12, and the rotation speed at this time can be set to, for example, 100 rpm to 200 rpm.

One or both of the nozzle arms 61, 62 move(s) to the position above the wafer W to jet the activating liquid. The activating liquid supplied from the nozzle arms 61, 62 is, for example, a solution of palladium chloride. The activating liquid is intended for quick formation of a copper film on the wafer W by electroless plating that is to be performed later. As for an amount to be jetted at this time, for example, about 100 mL will suffice for forming a puddle (layer) of the treatment liquid on the wafer W. However, the amount to be jetted may be increased when necessary.

(5) Clean and Dry Wafer W (Step S5, and FIG. 8 and FIG. 9)

The wafer W is cleaned with pure water and thereafter dried. This step is substantially the same as Step S3, and therefore, description thereof will be omitted.

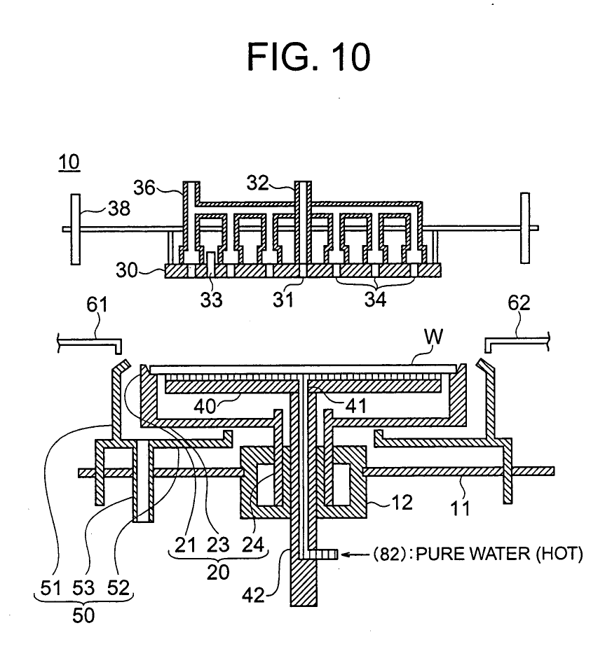

(6) Heat Wafer W (Step S6 and FIG. 10)

The wafer W is heated so as to be kept at an appropriate temperature for the reaction of the plating solution.

The heated lower plate 40 is brought close to the bottom face of the wafer W (an example of the interval between the bottom face of the wafer W and the top face of the lower plate 40: about 0.1 mm to about 2 mm), to supply the pure water heated in the liquid supply mechanism 80 from the treatment liquid jetting port 41. The heated pure water is filled between the bottom face of the wafer W and the top face of the lower plate 40 to heat the wafer W.

Note that rotating the wafer W while it is being heated can improve uniformity of heating the wafer W.

A liquid such as the pure water is used to heat the wafer W, which makes it easy to rotate the wafer W and the lower plate 40 separately or separately stop the rotation thereof, and prevents the contamination of the bottom face of the wafer W.

The above-described heating of the wafer W may be performed by other means. The wafer W may be heated, for example, by radiant heat of a heater or a lamp. Further, depending on cases, the heated lower plate 40 may be brought into contact with the wafer W to heat the wafer W.

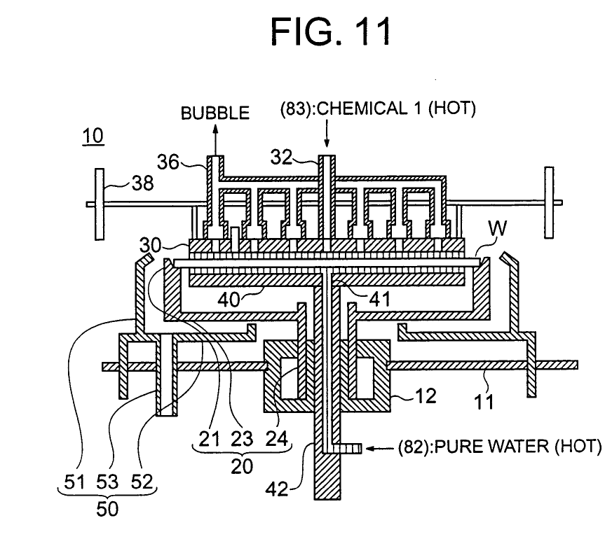

(7) Supply Plating Solution (Step S7 and FIG. 11)

The heated upper plate 30 is brought close to the top face of the wafer W (an example of the interval between the top face of the wafer W and the bottom face of the upper plate 30: about 0.1 mm to about 2 mm), to supply the chemical for plating (plating solution) from the treatment liquid jetting port 31 (for example, at 30 mL/min to 100 mL/min). The supplied plating solution is filled between the top face of the wafer W and the bottom face of the upper plate 30 to flow out into the cup 50. At this time, the plating solution is temperature-adjusted by the upper plate 30 (for example, within a range from room temperature to about 90° C.). Note that the supplied plating solution is preferably temperature-adjusted in advance in the liquid supply mechanism 80.

Here, the wafer W is rotated by the wafer chuck 20, so that uniformity of a plating film formed on the wafer W can be improved. The wafer W is rotated at, for example, 10 rpm to 50 rpm.

Alternatively, the upper plate 30 may be heated beforehand somewhere in the previous Steps S1 to S6. The parallel performance of the heating of the upper plate 30 with the other processes can reduce the time required for treating the wafer W.

The bubbles are removed in the following manner during the above-described supply of the plating solution.

The bubbles generated in the plating solution held between the upper plate 30 and the wafer W are discharged out of the plating solution from the bubble removal ports 34 through the bubble outflow portion 36 to the gas/liquid separating and collecting unit 90. The bubbles are generated because gas between the wafer W and the upper plate 30 is included in the plating solution or gas (for example, hydrogen) is generated from the plating solution as the plating progresses. The generated bubbles are discharged from the bubble removal ports 34, so that uniformity of the plating of the wafer W is improved.

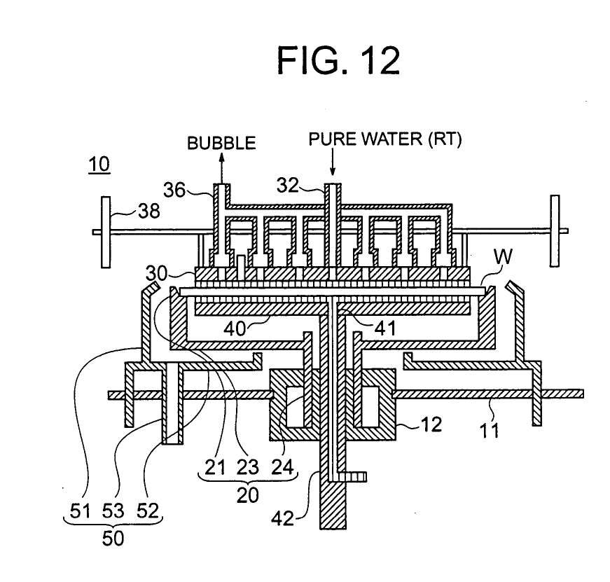

(8) Clean Wafer W (Step S8 and FIG. 12)

The wafer W is cleaned with pure water. This cleaning can be performed in such a manner that the valve V4 is opened to inject the pure water to the treatment liquid inflow portion 32 and the pure water is jetted from the treatment liquid jetting port 31 of the upper plate 30.

The wafer W is rotated while being cleaned, so that uniformity of the cleaning of the wafer W can be improved.

The bubbles are removed from the pure water also while the wafer W is cleaned. This removal is substantially the same as that in Step S7, and therefore, description thereof will be omitted.

(9) Post-Treatment of Wafer W (Step S9 and FIG. 7)

The wafer W is post-treated in such a manner that the wafer W is rotated and the post-treatment liquid (for example, sulfuric acid) is supplied from the nozzle arm 61 or the nozzle arm 62 to the top face of the wafer W.

(10) Clean and Dry Wafer W (Step S10, and FIG. 8 and FIG. 9)

The wafer W is cleaned with pure water and thereafter dried. This step is substantially the same as Step S3, and therefore, description thereof will be omitted.

(11) Carry Out Wafer W (Step S11 and FIG. 6)

After the drying of the wafer W is finished, the wafer chuck 20 stops holding the wafer W. Thereafter, the not-shown suction arm (substrate transfer mechanism) carries out the wafer W from the surface of the wafer chuck 20.

### Other Embodiments

The present invention is not limited to the above-described embodiment, and expansion and change thereof may be made. The expanded and changed embodiments are also included in the technical range of the present invention.

(1) As a substrate, a glass substrate or the like, for example, can be used other than the wafer W.

(2) The supply of the treatment liquid (including the plating solution) is not necessarily performed continuously, but may be performed somewhat intermittently. A fresh treatment liquid is supplied onto the substrate at least while the treatment liquid is supplied to the substrate, so that treatment uniformity of the substrate can be maintained. Further, even when the supply of the treatment liquid is temporarily stopped, treatment uniformity of the substrate is not greatly impaired unless the treatment liquid greatly changes during the stop period.

What is claimed is:

1. An electroless plating apparatus comprising:
a substrate holding unit configured to hold a substrate;
a plate disposed to face the substrate held by said substrate holding unit;
a treatment liquid jetting portion formed in said plate and configured to jet a treatment liquid;
a bubble discharge portion formed in said plate and configured to discharge a bubble in the treatment liquid held between said plate and the substrate; and
an interval adjusting unit configured to vary an interval between said plate and the substrate.

2. The electroless plating apparatus as set forth in claim 1,
wherein said bubble discharge portion has an opening formed on said plate and a pipe connected to the opening.

3. The electroless plating apparatus as set forth in claim 2,
wherein said plate has a slope formed thereon in a direction toward the opening.

4. The electroless plating apparatus as set forth in claim 3,
wherein the slope has an angle of 2° or more relative to a surface of said plate.

5. The electroless plating apparatus as set forth in claim 2,
wherein said plate has a groove formed thereon and the opening is disposed in the groove.

6. The electroless plating apparatus as set forth in claim 5,
wherein the groove has a slope on a side face thereof in a direction toward the opening.

7. The electroless plating apparatus as set forth in claim 6,
wherein the slope has an angle of 2° or more relative to a surface of said plate.

8. The electroless plating apparatus as set forth in claim 2, further comprising:
a gas/liquid separator connected to the pipe.

9. The electroless plating apparatus as set forth in claim 2, further comprising:
a pressure reducing unit configured to reduce a pressure in the pipe.

10. The electroless plating apparatus as set forth in claim 2, further comprising:
a rinsing liquid injecting unit configured to inject a rinsing liquid into the pipe.

11. An electroless plating method, comprising:
placing a plate and a substrate to be adjacent to and face each other, the plate including a treatment liquid jetting portion configured to jet a treatment liquid and a bubble discharge portion configured to discharge a bubble in the treatment liquid;
jetting the treatment liquid from the treatment liquid jetting portion to form a layer of the treatment liquid between the plate and the substrate; and
discharging the bubble in the layer of the treatment liquid from the bubble discharge portion during the supply of the treatment liquid.

12. The electroless plating method as set forth in claim 11,
wherein the bubble discharge portion has an opening formed on the plate and a pipe connected to the opening.

13. The electroless plating method as set forth in claim 12,
wherein the plate has a slope formed thereon in a direction toward the opening.

14. The electroless plating method as set forth in claim 13,
wherein the slope has an angle of 2° or more relative to a surface of the plate.

15. The electroless plating method as set forth in claim 12,
wherein the plate has a groove formed thereon and the opening is disposed in the groove.

16. The electroless plating as set forth in claim 15,
wherein the groove has a slope on a side face thereof in a direction toward the opening.

17. The electroless plating method as set forth in claim 16,
wherein the slope has an angle of 2° or more relative to a surface of the plate.

18. The electroless plating method as set forth in claim 12, further comprising
separating gas and liquid from each other by a gas/liquid separator connected to the pipe.

19. The electroless plating method as set forth in claim 12, further comprising:
reducing a pressure in the pipe by a pressure reducing unit.

20. The electroless plating method as set forth in claim 12, further comprising:
injecting a rinsing liquid into the pipe by a rinsing liquid injecting unit.
